(19) United States
(12) Patent Application Publication
(10) Pub. No.: US 2015/0306754 A1
(43) Pub. Date: Oct. 29, 2015

(54) DISC POSITIONING ATTACHMENT FOR A FASTENER DRIVING TOOL

(71) Applicant: Illinois Tool Works Inc., Glenview, IL (US)

(72) Inventor: Craig E. Pappin, Hamilton (CA)

(21) Appl. No.: 14/671,437

(22) Filed: Mar. 27, 2015

Related U.S. Application Data
(60) Provisional application No. 61/983,642, filed on Apr. 24, 2014.

(51) Int. Cl. B25C 7/00; B25C 5/16; B25C 1/04

(52) U.S. Cl. CPC B25C 7/00; B25C 1/04; B25C 5/1693

(57) ABSTRACT

A fastener driving tool and an attachment for positioning a disc at a nosepiece of the fastener driving tool are provided. The fastener driving tool includes a tool body having the nosepiece extending along a discharge axis for discharging a fastener, and the attachment. The attachment includes a coupling section having a body defining a hollow portion configured to receive at least a portion of the nosepiece of the fastener driving tool and a positioning section adjacent to the coupling section, the positioning section including a lip defining a slotted area having an open side configured to receive the disc and at least one magnet for magnetically holding the disc in the positioning section.

### BACKGROUND

The following description relates to an attachment for a tool, for example, a disc positioning attachment for a fastener driving tool to position a disc along a discharge axis so that a fastener may be discharged through the disc.

A rigid insulation board may be fastened to a wooden stud using a nail. The board, although rigid, may be somewhat flexible or crushable. As such, the ability to secure the board may be limited due to the relatively small diameter of the head of the nail. To better secure the board, it is known to secure the nail in the insulation board by positioning the nail through an opening of a washer or disc and then driving the nail through the rigid insulation board and the wooden stud so that the washer is positioned between the head of the nail and the rigid insulation board. Accordingly, a contact area of the fastener, i.e., the nail and the washer, is increased, and pressure exerted on the rigid insulation board by the head of the nail may be spread over the area of the washer.

Known methods of securing the nail to the rigid insulation board and wooden stud include hand nailing an assembled cap and nail, or using a pneumatic nailer with a plastic disc coil feeding unit. However, hand nailing the assembled cap and nail is time consuming and labor intensive. Using the pneumatic nailer may decrease time and labor. However, the plastic discs may not be sufficiently strong for all applications.

Another known apparatus for securing the nail to the rigid insulation board is a round, lipped position plate located at a discharge end of a pneumatic nailer. The washer may be made of a magnetic material and held against the round, lipped position plate by a pair of magnets located 180 degrees apart. The round, lipped position plate includes an opening through which a discharged nail may be received. An opening formed in the washer must be aligned with the opening of the position plate, which, in turn, is aligned with a discharge axis formed along the pneumatic nailer. As the discharged nail travels through the respective openings, the head of the nail engages the washer and removes the washer from the round, lipped position plate and transfers the washer to the rigid insulation board.

However, positioning the washer on the round, lipped position plate must be done by hand. Proper positioning such that the respective openings are aligned requires a visual confirmation by an operator that the openings of the washer and position plate are aligned, so that the discharged nail may be received through both. The manual positioning of the washer on the position plate, repeated for every nailing operation, may be time consuming.

Accordingly, it is desirable to provide a fastener driving tool having an attachment on which the washer may be easily and accurately positioned and does not require visual confirmation of the washer position.

### SUMMARY

According to one aspect, there is provided an attachment for positioning a disc at a nosepiece of a fastener driving tool. The attachment includes a coupling section having a body defining a hollow portion configured to receive at least a portion of the nosepiece of the fastener driving tool and a positioning section adjacent to the coupling section, the positioning section including a lip defining a slotted area having an open side configured to receive the disc and at least one magnet for magnetically holding the disc in the positioning section.

According to another aspect, there is provided a fastener driving tool including a tool body having a nosepiece extending along a discharge axis for discharging a fastener, and an attachment for positioning a disc at the nosepiece. The attachment includes a coupling section having a body defining a hollow portion configured to receive at a least a portion of the nosepiece and a positioning section adjacent to the coupling section, the positioning section including a lip defining a slotted area having an open side configured to receive the disc and at least one magnet for magnetically holding the disc in the positioning section.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is perspective view of a fastener driving tool having an attachment for positioning a disc according to one embodiment;

FIG. 2 is an enlarged perspective view of the attachment for positioning the disc on the fastener driving tool of FIG. 1;

FIG. 3 is perspective view of the attachment for positioning the disc of FIG. 1; and

FIGS. 4A and 4B are diagrams showing the disc being inserted into the attachment and fully inserted into the attachment, respectively, according to an embodiment described herein.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

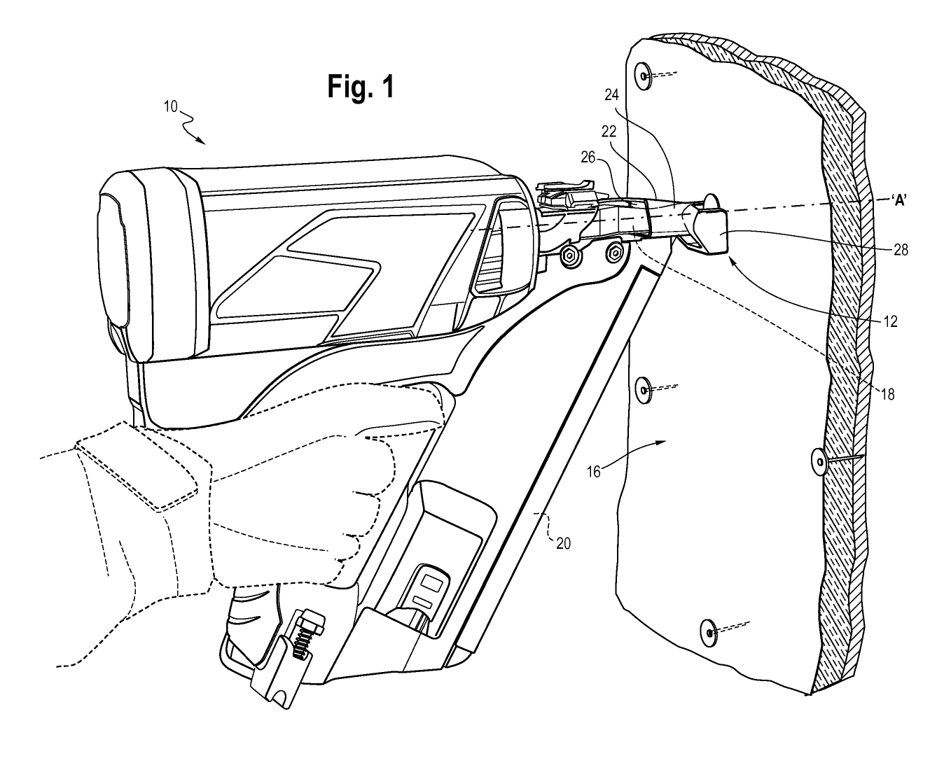

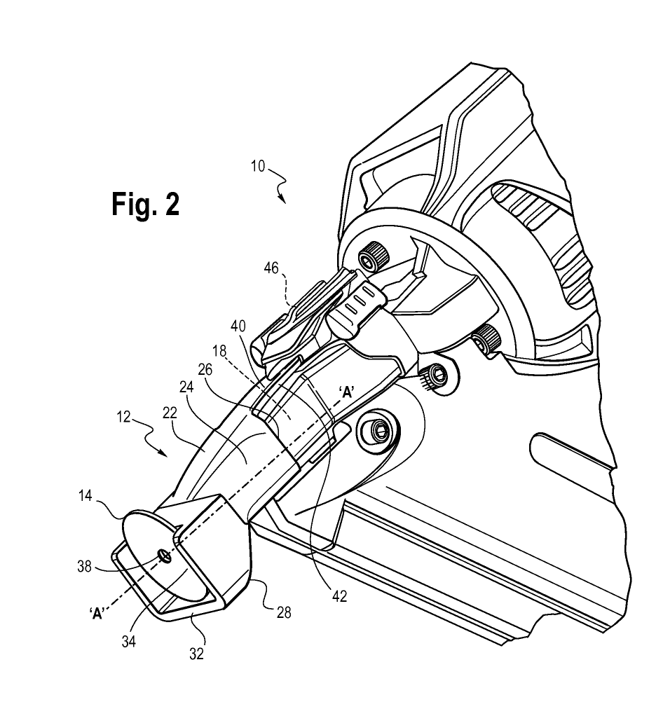

FIG. 1 is perspective view of a fastener driving tool 10 having an attachment 12 for positioning a disc 14 (see FIGS. 2-4) according to an embodiment described herein. The fastener driving tool 10 is configured to drive a fastener (not shown) into a work piece 16. The fastener driving tool 10 includes a nosepiece 18 that is configured to receive the fastener from a fastener magazine 20 and internal driving elements (not shown) that are configured to drive the fastener through the nosepiece 18 to discharge the fastener therefrom. The nosepiece 18 extends along a discharge axis ‘A’, and the fastener is discharged along the discharge axis ‘A’. The fastener driving tool 10 may be, for example, a nailer, and in some examples, may be a cordless and/or pneumatic nailer. The nailer is configured to drive a nail into the work piece 16.

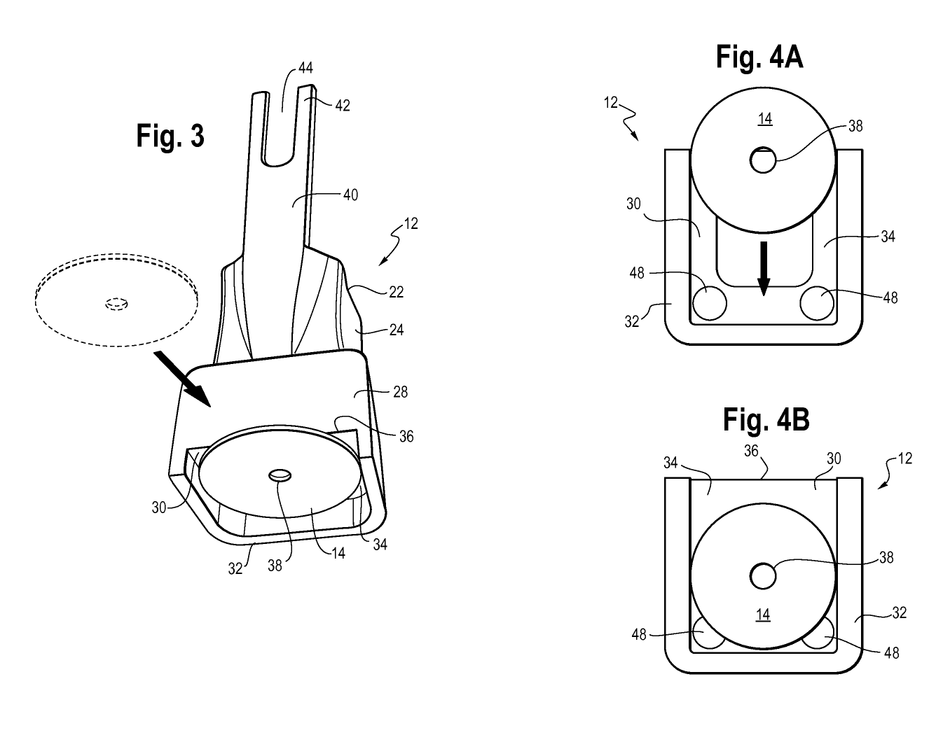

FIG. 2 is a perspective view of the attachment 12 on a fastener driving tool 10 according an embodiment described herein. FIG. 3 is a perspective view of the attachment 12. Referring to FIGS. 1-3, the attachment 12 is coupled to an end of the nosepiece 18 through which the fastener is discharged. In on embodiment, the attachment 12 includes a coupling section 22. The coupling section 22 includes a body 24 defining a hollow portion 26 configured to receive at least a portion of the nosepiece 18. The attachment 12 further includes a positioning section 28 adjacent to the coupling section 22. The positioning section 28 may be separated from the coupling section 22 by a wall 30. That attachment 12 may be formed as a single, unitary piece. Alternatively, the attachment 12 may be formed by separate parts fastened together using known fastening techniques.

Referring to FIGS. 2 and 3, the positioning section 28 includes a lip 32 defining a slotted area 34. The lip 32 extends partially about a periphery of the positioning section. The slotted area 34 includes an open side 36 configured to receive the disc 14 therethrough into the slotted area 34, substantially radially relative to the discharge axis ‘A’. In one embodiment, the positioning section 28 may be generally square or rectangular in cross section when viewed along the discharge axis ‘A’. The lip 32 may extend about three sides of the rectangle or square, leaving one peripheral side open (i.e., the open side 36) to receive the disc 14. The lip 32, in use, is configured to contact the work piece 16 (see FIG. 1).

The disc 14 may be of a predetermined size and diameter for a particular application. For example, the disc 14 may be of a size and diameter suitable for use with a nail for fastening rigid insulation to an underlying board or stud. The positioning section 28, and in particular, the lip 32, is sized to correspond to a diameter of the disc 14. For example, opposing sides of the lip 32 may be spaced apart by a distance that substantially corresponds to, or is slightly greater than the diameter of the disc 14. Likewise, a segment of the lip 32 extending between the opposing sides and opposing the open side 36 extends at a length that corresponds to, or is slightly greater than the diameter of the disc 14. Accordingly, the lip 32 is configured to position and support the disc 14 within the slotted area 34 at the positioning section 28. That is, the lip 32 is sized and dimensioned such that the disc 14 is maintained in a proper position via contact with the lip 32.

In addition, the disc 14 includes a centrally positioned aperture 38 configured to receive the fastener (not shown) discharged from the fastener driving tool 10. Accordingly, the disc 14 and lip 32 of the positioning section 28 on the attachment 12 are sized such that the central aperture 38 is positioned on the discharge axis ‘A’ when the disc 14 is positioned in the slotted area 34 and supported by the lip 32. In addition, the lip 32 and the positioning section 28 may be dimensioned such that when a correspondingly (or properly) sized disc 14 is positioned therein, a portion of the disc 14 extends through the open side 36 beyond an outer extent of the positioning section 28. That is, with the disc 14 properly positioned in the positioning section 28, with the central aperture 38 aligned on the axis ‘A’, and the disc 14 is substantially held against movement out of the proper position by the lip 32, a radial extent of the disc 14 may extend beyond an outer extent of the positioning section 28 at the open side 36. Accordingly, an operator may be able to visually confirm, from multiple positions, that the disc 14 has been positioned at the positioning section 28 of the attachment 12.

In the embodiments described herein, it is understood that the positioning section 28, and in particular the lip 32 and the slotted area 34 are sized and dimensioned to generally correspond to a size and dimension (e.g., the diameter) of the disc 14. That is, the lip 32 and slotted area 34 are dimensioned so that a disc 14 positioned within the slotted area 34 contacts, or is within predetermined acceptable clearances from all sides of the lip 32 to substantially hold the disc 14 against movement out of the proper position, such that the central aperture 38 remains positioned on the axis ‘A’.

With further reference to FIGS. 2 and 3, the coupling section 22 may also include a coupling tongue 40 extending from the body 24. The coupling tongue 40 extends axially beyond the hollow portion 26 defined by the body 24 and is configured to be secured to the fastener driving tool 10. The coupling tongue 40 may be formed as a generally flat leaf section, and includes an engagement portion 42 that may be formed at or near a distal end of the coupling tongue 40. In one embodiment, the engagement portion 42 may be formed as a fork having an elongated open slot 44 formed therein, configured to engage a corresponding engagement portion 46 of the fastener driving tool 10. The corresponding engagement portion 46 of the fastener driving tool 10 may be, for example, an integrally formed portion of the fastener driving tool 10 and/or include a separate securing element(s) configured to secure the engagement portion 42 of the coupling tongue 40 to the fastener driving tool 10. The coupling tongue 40 may be adjustably positioned on or secured to the nosepiece 18 (at the corresponding engagement portion 46) of the driver fastening tool 10 so that the attachment 12 may be secured at different axial positions along the nosepiece 18. Accordingly, by way of axial adjustment of the attachment 12, for example, along axis ‘A’, a depth that the fastener discharged from the fastener driving tool 10 is driven into the work piece 16 may be adjusted. That is, axial adjustment of the attachment 12 relative to the nosepiece 18 adjusts a distance that a free end of the nosepiece 18 is positioned from the work piece 16, thereby adjusting the depth of drive of the fastener into the work piece 16.

It is understood that the engagement portion of the coupling tongue 40 is not limited to the example above, and other configurations are envisioned. For example, the engagement portion 42 of the coupling tongue 40 may include a closed elongated slot, one or more than one circular or non-circular apertures, or an interlocking securing component or components configured to directly engage the fastener driving tool 10 to secure the coupling tongue 40 thereto. Interlocking securing components may include, for example, components of a snap-fit or interference fit fastener. The separate securing element(s) may include known suitable securing elements, such as, but not limited to, bolts, screws, set screws, pins, clamps and other similarly suitable elements.

In one embodiment, the corresponding engagement portion 46 may be formed at or secured to the nosepiece 18 of the fastener driving tool 10. The corresponding engagement portion 46 may be received in the elongated open slot 44 of the coupling tongue 40 and secure the engagement portion 42 of the coupling tongue 40 to the nosepiece 18. In one embodiment, the corresponding engagement portion 46 may be a clamping mechanism that applies a clamping force to the coupling tongue 40 to secure the coupling tongue 40 to the nosepiece 18 sufficient to prevent or limit unintentional movement of the coupling tongue 40 relative to the nosepiece 18.

FIGS. 4A and 4B are front views of the attachment 12 showing a disc 14 being received therein. Referring to FIGS. 4A and 4B, the positioning section 28 further includes at least one magnet 48. In one embodiment, the at least one magnet 48 is positioned near or adjacent to the lip 32 at the segment opposite to the open side 36. For example, where the open side 36 is formed at a top of the positioning section 28, the at least one magnet 48 may be positioned at or near the bottom of the positioning section 28. In addition, the at least one magnet 48 may include two spaced apart magnets 48. The two spaced apart magnets 48 may be positioned adjacent to opposing sides of the lip 32. The at least one magnet 48 is configured, in part, to draw the disc 14 through the slotted area 34 to properly position the disc 14 within the slotted area 34 at the positioning section 28, and to hold the disc 14 within the slotted area 34 until the fastener is discharged through the central aperture of the disc 14, and the head of the fastener engages and releases the disc 14 from the attachment 12. The at least one magnet 48 may be embedded in or flush with the wall 30.

In use, according to one example, the attachment 12 is positioned on the nosepiece 18 of the fastener driving tool 10 by receiving a portion of the nosepiece 18 in the hollow portion 26 defined by the body 24 of the coupling section 22. In addition, the engagement section 42 of the coupling tongue 40 may be secured to a corresponding engagement section 46 of the nosepiece 18. With the attachment 12 positioned on the fastener driving tool 10, the positioning section 28 is configured to hold a correspondingly dimensioned disc 14 such that a central aperture 38 of the disc 14 is aligned with the discharge axis ‘A’. Further, as noted above, the attachment 12 may include the wall 30 between the positioning section 28 and the coupling section 22. The wall 30 includes a wall opening (not shown) through the discharge axis ‘A’ extends. The wall opening is sufficiently sized to allow the fastener, including the head, to be discharged therethrough entirely.

The disc 14 may be received in the slotted area 34 defined by the lip 32 of the positioning section 28. In one embodiment, the lip 32 extends around three sides of a generally square or rectangular shape to define the open side 36. An operator may slide the disc 14 into the slotted area 34 through the open side 36. The disc 14 is guided on lateral sides by the opposing sides of the lip 32, and is properly positioned within the slotted area 34 by abutting the segment of the lip 32 opposing the open side 36 (i.e., the side of the lip between the opposing sides). The at least one magnet 48 may attract the disc 14 to this position. In addition, the at least one magnet 48 is configured to hold the disc 14 in this position until the fastener is discharged through the disc 14. In some examples, the force from the at least one magnet 48 may allow the operator to release the disc 14 while only partially received in the slotted area 34. The attractive force from the at least one magnet 48 may draw the disc 14 to the segment of the lip 32 opposing the open side 36 to properly position the disc 14 in the slotted area 34. In addition, with the disc 14 properly positioned in the slotted area 34, the central aperture 38 is positioned along and aligned with the discharge axis ‘A’.

The fastener driving tool 10 may then be operated to discharge a fastener. The fastener may be, for example, a nail having a head. The nail is discharged from the nosepiece 18 along the discharge axis ‘A’ and through the central aperture 38. The head of the fastener engages the disc 14 proximate to the central aperture 38. The force imparted on the disc 14 by the head causes the disc 14 to be released from the at least one magnet 48 and removed from the attachment 12 such that the disc 14 is transferred with the nail and secured to the work piece 16.

In the embodiments above, an operator may properly and quickly position a disc 14 in the positioning section 28 of the attachment 12 without visual inspection for alignment of the central aperture 38 with the discharge axis ‘A’. Accordingly, incremental time savings may be realized where multiple fastener and disc 14 combinations are being secured to a work piece 16.

It should also be understood that various changes and modifications to the presently disclosed embodiments will be apparent to those skilled in the art. Such changes and modifications can be made without departing from the spirit and scope of the present disclosure and without diminishing its intended advantages. It is therefore intended that such changes and modifications be covered by the appended claims.

1. An attachment for positioning a disc at a nosepiece of a fastener driving tool, the attachment comprising:
a coupling section having a body defining a hollow portion configured to receive at least a portion of the nosepiece of the fastener driving tool; and
a positioning section adjacent to the coupling section, the positioning section including a lip defining a slotted area having an open side configured to receive the disc and at least one magnet for magnetically holding the disc in the positioning section.

2. The attachment of claim 1, the coupling section further comprising a coupling tongue extending from the body, the coupling tongue having an engagement portion configured to engage a corresponding engagement portion at the fastener driving tool.

3. The attachment of claim 1, wherein the lip of the positioning section is configured to position a central opening of the disc along a discharge axis defined by the nosepiece of the fastener driving tool and along which a discharged fastener travels so that the discharged fastener is received through the central opening.

4. The attachment of claim 1, wherein the at least one magnet is positioned adjacent to the lip at an opposite end of the slotted area from the open side.

5. That attachment of claim 1, wherein the disc is made of a magnetic metal material.

6. The attachment of claim 1, wherein the positioning section is separated from the coupling section by a wall.

7. A fastener driving tool comprising:
a tool body having a nosepiece extending along a discharge axis for discharging a fastener; and
an attachment for positioning a disc at the nosepiece, the attachment comprising:
a coupling section having a body defining a hollow portion configured to receive at a least a portion of the nosepiece; and
a positioning section adjacent to the coupling section, the positioning section including a lip defining a slotted area having an open side configured to receive the disc and at least one magnet for magnetically holding the disc in the positioning section.

8. The fastener driving tool of claim 7, the coupling section further comprising a coupling tongue extending from the body, the coupling tongue having an engagement portion configured to engage a corresponding engagement portion at the fastener driving tool.

9. The fastener driving tool of claim 7, wherein the lip of the positioning section is configured to position a central opening of the disc along the discharge axis which a discharged fastener travels so that the discharged fastener is received through the central opening.

10. The fastener driving tool of claim 7, wherein the at least one magnet is positioned adjacent to the lip at an opposite end of the slotted area from the open side.

11. The fastener driving tool of claim 7, wherein the positioning section is separated from the coupling section by a wall.

12. That fastener driving tool of claim 7, wherein the disc is made of a magnetic metal material.

13. The fastener driving tool of claim 7, wherein the fastener driving tool is a nailer and the fastener is a nail.

14. The fastener driving tool of claim 13, wherein the nailer is a pneumatic nailer.

15. The fastener driving tool of claim 13, wherein the nailer is a cordless nailer.
